(19) United States
(12) Patent Application Publication
(10) Pub. No.: US 2012/0260196 A1
(43) Pub. Date: Oct. 11, 2012

(54) APPARATUS AND METHOD FOR SHARING INFORMATION IN VIRTUAL SPACE

(75) Inventors: Ji-Hoon KIM, Seoul (KR); Won-Suk Chang, Hwaseong-si (KR); Dong-Chang Lee, Dong-gu (KR); An-Na Park, Seoul (KR); Dong-Hoon Jang, Suwon-si (KR); Seong-Taek Hwang, Pyeongtaek-si (KR)

(73) Assignee: Samsung Electronics Co., Ltd., Gyeonggi-do (KR)

(21) Appl. No.: 13/333,264

(22) Filed: Dec. 21, 2011

(30) Foreign Application Priority Data
Apr. 11, 2011 (KR) 10-2011-0033504

(51) Int. Cl. G06F 3/048

(52) U.S. Cl. 715/753

(57) ABSTRACT

A method and apparatus for sharing information in a virtual space are provided. Upon receiving a bulletin space-generation request, generating a bulletin space and displays the bulletin space on a screen. Upon receiving a bulletin content-creation request, executing a bulletin content-creation tool stored in the memory unit and displaying the bulletin content-creation tool on the screen. When a bulletin content is created by the bulletin content-creation tool, storing the created bulletin content corresponding to the bulletin space and displaying the bulletin content on the screen.

### PRIORITY

This application claims priority under 35 U.S.C. §119(a) to a Korean Patent Application filed in the Korean Intellectual Property Office on Apr. 11, 2011 and assigned Serial No. 10-2011-0033504, the entire disclosure of which is incorporated herein by reference.

### BACKGROUND OF THE INVENTION

1. Field of the Invention

The present invention relates generally to an apparatus and method for sharing information, and more particularly, to an apparatus and method for generating a virtual bulletin space in a portable terminal, creating information in the generated virtual bulletin space, and sharing the created information.

2. Description of the Related Art

Various Social Networking Services (SNSs) such as twitter and facebook have boomed universally in recent years.

This SNS technology helps users enhance their relationships with acquaintances, friends, classmates and colleagues, make more personal connections, and form a large wide human network.

A general SNS method writes and registers messages in the same manner as a method of writing and registering messages on a bulletin board.

When a user inputs a desired text into a text window and presses a registration button to register the text on a website, other users may access the website and view the input text. The user may attach media files (for example, Pictures and Moving Pictures) to a bulletin text. When other users access a bulletin board on a website and select desired message titles from a message list, they can view the messages corresponding to the message titles selected on the website.

In the conventional method, the user uses an SNS to post and register messages by writing the messages on a general bulletin board.

However, the need to perform a vertical scroll operation for registration of a bulletin text may make users less likely to write various bulletin messages.

If devices such as Personal Computers (PCs) and portable terminals are used to create and view bulletin content, an SNS server is accessed through an SNS website to provide an SNS. Therefore, the web server-based SNS method may cause server maintenance costs.

### SUMMARY OF THE INVENTION

An embodiment of the present invention is to provide an apparatus and method for generating a virtual bulletin space, registering bulletin content with a desired design, at a desired point in the virtual bulletin space, in a desired manner, and sharing the bulletin content with other users.

According to an embodiment of the present invention, an apparatus for sharing information in a virtual space includes an input unit for receiving user input; a memory unit for storing data used to create bulletin content; a display unit for displaying a bulletin content-creation screen; and a control unit for generating, upon receiving a bulletin space-generation request, a bulletin space and displaying the bulletin space on the display unit; executing, upon receiving a bulletin content-creation request, a bulletin content-creation tool stored in the memory unit and displaying the bulletin content-creation tool on the display unit; and storing a bulletin content corresponding to the bulletin space, created by the bulletin content-creation tool, in the memory unit and displaying the bulletin content on the display unit.

According to an embodiment of the present invention, an apparatus for sharing information in a virtual space includes: an input unit for receiving user input; a memory unit for storing data used to create bulletin content; a display unit for displaying a bulletin content-creation screen; a data-communicating unit for communicating with a server terminal; and a control unit for connecting to the server terminal through the data-communicating unit and using the display unit to display a bulletin space provided by the server terminal; executing, upon receiving a bulletin content-creation request, a bulletin content-creation tool stored in the memory unit and displaying the bulletin content-creation tool on the display unit; and storing a bulletin content corresponding to the bulletin space, created by the bulletin content-creation tool, in the memory unit and displaying the bulletin content on the display unit.

According to an embodiment of the present invention, a method for sharing information in a virtual space includes: generating, upon receiving a bulletin space-generation request, a bulletin space and displaying the bulletin space on a screen; executing, upon receiving a bulletin content-creation request, a bulletin content-creation tool stored in the memory unit and displaying the bulletin content-creation tool on the screen; and storing, when a bulletin content is created by the bulletin content-creation tool, the created bulletin content corresponding to the bulletin space, and displaying the bulletin content on the screen.

According to an embodiment of the present invention, a method for sharing information in a virtual space includes: upon receiving a request for generation of a bulletin space for creation of a bulletin content, connecting communication with a server terminal and displaying a bulletin space, provided by the server terminal, on a screen; upon receiving a bulletin content-creation request, executing a bulletin content-creation tool stored in the memory unit and displaying the bulletin content-creation tool on the on the screen; and storing a bulletin content corresponding to the bulletin space, created by the bulletin content-creation tool, and displaying the bulletin content on the screen.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram of a server terminal providing a virtual bulletin space according to an embodiment of the present invention;

FIG. 2 is a block diagram of a client terminal according to an embodiment of the present invention;

FIG. 3 is a flow diagram illustrating a process for providing a Social Networking Service (SNS) by a server terminal according to an embodiment of the present invention;

FIG. 4 is a flow diagram illustrating a process for accessing, by a client terminal, a server terminal to use a Social Networking Service (SNS) according to an embodiment of the present invention;

FIG. 5 is a flow diagram illustrating a process for accessing, by a client terminal, a bulletin space in a server terminal to use a Social Networking Service (SNS) according to an embodiment of the present invention;

FIG. 6 illustrates a bulletin content-creation tool screen and bulletin content created in a bulletin space according to an embodiment of the present invention;

FIG. 7 illustrates applying an effect to bulletin content according to an embodiment of the present invention;

FIG. 8 illustrates supporting a multi-page mode according to an embodiment of the present invention;

FIG. 9 illustrates changing from a bulletin space screen to a list-type bulletin content screen according to an embodiment of the present invention;

FIG. 10 illustrates a plurality of bulletin spaces and the relationship between users sharing the bulletin spaces according to an embodiment of the present invention; and

FIG. 11 illustrates a bulletin space screen including a plurality of bulletin content according to an embodiment of the present invention.

### DETAILED DESCRIPTION OF EMBODIMENTS OF THE PRESENT INVENTION

Embodiments of the present invention will be described below in detail with reference to the accompanying drawings. The present invention may, however, be embodied in different forms and should not be construed as limited to the embodiments set forth herein. Rather, these embodiments are provided to make this disclosure thorough and complete, and fully convey the scope of the present invention to those skilled in the art. Like reference numerals in the drawings denote like elements. In the following description, detailed descriptions of well-known functions or configurations will be omitted since they would unnecessarily obscure the subject matters of the present invention.

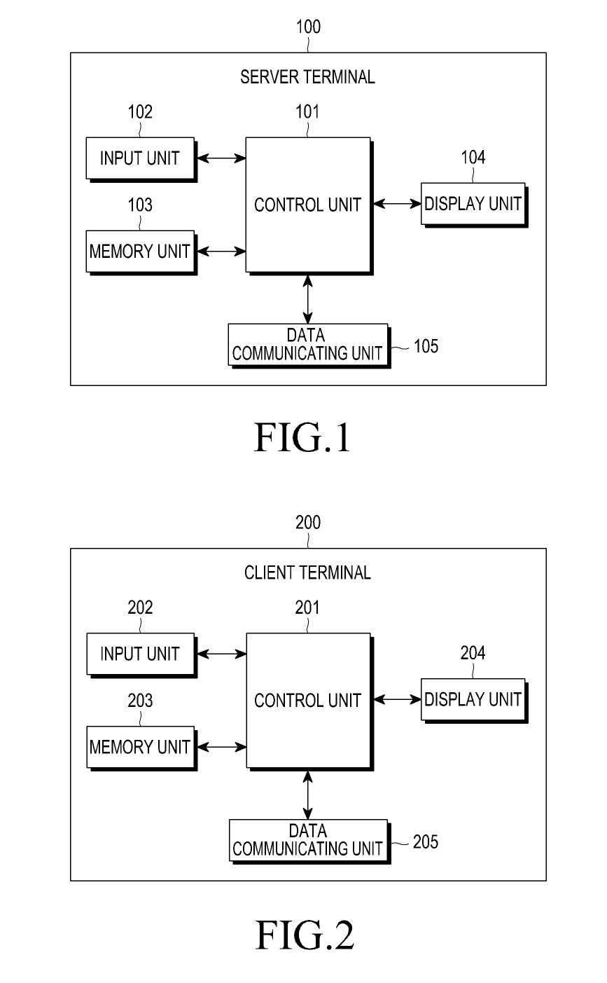

FIG. 1 is a block diagram of a server terminal providing a virtual bulletin space according to an embodiment of the present invention.

In an embodiment of the present invention, a server terminal performs data communication with client terminals to enable access to a bulletin space. The bulletin space is a virtual space that is provided to allow users to freely create bulletin content.

Referring to FIG. 1, a server terminal 100, according to an embodiment of the present invention, may include a control unit 101, an input unit 102, a memory unit 103, a display unit 104, and a data-communicating unit 105.

The control unit 101 controls the overall operation of the server terminal 100. According to an embodiment, when receiving a bulletin space-generation request through the input unit 102, the control unit 101 generates a bulletin space.

When receiving a request for creation of bulletin content at a point in the generated bulletin space, the control unit 101 executes a bulletin content-creation tool and displays a bulletin content-creation tool screen on the display unit 104. The bulletin content-creation tool may include various bulletin content-creation functions such as a note-taking (e.g., handwriting) input function, a text input function, a picture/video attachment function, and a drawing function.

The control unit 101 may determine whether a bulletin space size is sufficient for bulletin content-creation, and may generate a new bulletin space if the bulletin space size is insufficient for bulletin content-creation.

When bulletin content is input through the bulletin content-creation tool, the control unit 101 stores information about the input bulletin content and the bulletin space point, which is selected for the bulletin content input, in the memory unit 103. The control unit may determine whether there is a bulletin content already registered at the bulletin space point selected through the input unit 102, and may store the input bulletin content at the bulleting space point where there is no bulletin content. The bulleting data information may include a user input and a bulletin content-creation function used to create user bulletin content. In another embodiment, the control unit 101 may select a bulletin space point to register bulletin content, after completion of creation of the bulletin content. If there is another bulletin content already registered at the selected bulletin space point, the control unit 101 may display a message on the screen to notify another bulletin space point to the user, or the user may manually select another bulletin space point.

Also, the control unit 101 may insert an effect of a vibration pattern at a bulletin space point to register bulletin content by the bulletin content-creation tool, so that the user may experience a special feeling when selecting the bulletin content by touch.

The control unit 101 then uses the display unit 104 to display the bulleting data information stored at the selected bulletin space point.

In another embodiment, the control unit 101 transmits a bulletin content update notification to an external device to notify the creation of bulletin content. For example, the control unit 101 transmits the bulletin content update notification to a client terminal connected to the server terminal 100, or to a terminal that has installed a bulletin content-creation tool and has an address selected from an address book stored in the server terminal 100. Also, the control unit 101 may group a plurality of acquaintances registered in the address book and transmit a notification message to only the grouped acquaintances, or may or may not open bulletin content access.

The input unit 102 transmits a key signal, corresponding to a key pressed by the user, to the control unit 101. The input unit 102 may include a touchpad or a keypad including a plurality of keys.

The memory unit 103 stores a bulletin content-creation tool and bulletin content created by the bulletin content-creation tool. The memory unit 103 may store the created bulletin content and an input point of the created bulletin content in a bulletin space, in a corresponding manner. The memory unit 103 may also store at least one bulletin content-creation function used to create the bulletin content, in a corresponding manner.

The display unit 104 displays a generated bulletin space and an executed bulletin content-creation tool screen. Moreover, the display unit 104 displays created bulletin content.

The data-communicating unit 105 communicates least one client terminal by transmitting and receiving data. The data-communicating unit 105 may use data communication schemes such as Bluetooth® or WiFi®.

FIG. 2 is a block diagram of a client terminal according to an embodiment of the present invention.

Referring to FIG. 2, a client terminal 200 according to an embodiment of the present invention may include a control unit 201, an input unit 202, a memory unit 203, a display unit 204, and a data-communicating unit 205.

In an embodiment of the present invention, it is assumed that the client terminal 200 is connected to the server terminal 100 by data communication.

The control unit 201 connects to the server terminal 100 through the data-communicating unit 205. When the control unit 201 receives a bulletin content update notification from the server terminal 100, the control unit 201 determines whether there is a request for accessing a bulletin space provided by the server terminal 100. The bulletin content update notification may include information about a link and a shortcut for accessing a bulletin space generated in the server terminal 100. Accordingly, the control unit 201 can access the bulletin space.

When receiving a bulletin space access request through the input unit 202, the control unit 201 accesses a bulletin space of the server terminal 100 and displays a bulletin space screen on the display unit 204. If the client terminal 200 is not communicating with the server terminal 100, the control unit 201 may perform a communication connection with the server terminal 100 via a bulletin space access request.

When receiving an access request for any one of the bulletin content in the bulletin space through the input unit 202, the control unit 201 displays the requested bulletin content on the screen. If an image or a moving picture is attached to the bulletin content, the control unit 201 may display a subscreen for displaying the image or the moving picture in detail.

When receiving a request for creating bulletin content at a point of the bulletin space, the control unit 201 executes a bulletin content-creation tool stored in the memory unit 203 and displays a bulletin content-creation tool screen on the display unit 204.

When bulletin content is input at a selected point of the bulletin space by the bulletin content-creation tool through the input unit 202, the control unit 201 stores information about the selected bulletin space point and the bulletin content in the memory unit 203 in a corresponding manner. The control unit 201 may store the created bulletin content in the memory unit 203 of the client terminal 200 or in the memory unit 103 of the server terminal 100.

The control unit 201 then uses the display unit 204 to display the bulleting data created at the selected bulletin space point.

The input unit 202 transmits a key signal, corresponding to a key pressed by the user, to the control unit 201. The input unit 202 may include a touchpad or a keypad including a plurality of keys.

The memory unit 203 stores a bulletin content-creation tool and bulletin content created by the bulletin content-creation tool. The memory unit 203 may store the created bulletin content and an input point of the created bulletin content in a bulletin space, in a corresponding manner. The memory unit 203 may also store at least one bulletin content-creation function used to create the bulletin content, in a corresponding manner.

The display unit 204 displays a generated bulletin space and an executed bulletin content-creation tool screen. Also, the display unit 204 displays the created bulletin content.

The data-communicating unit 205 communicates data with at least one client terminal. The data-communicating unit 205 may use data communication schemes such as Bluetooth and WiFi.

As described above, an embodiment of the present invention generates a virtual bulletin space, registers bulletin content with a desired design, at a desired point in the virtual bulletin space, in a desired manner, and shares the bulletin content with other users, thereby making it possible to create user-specific content.

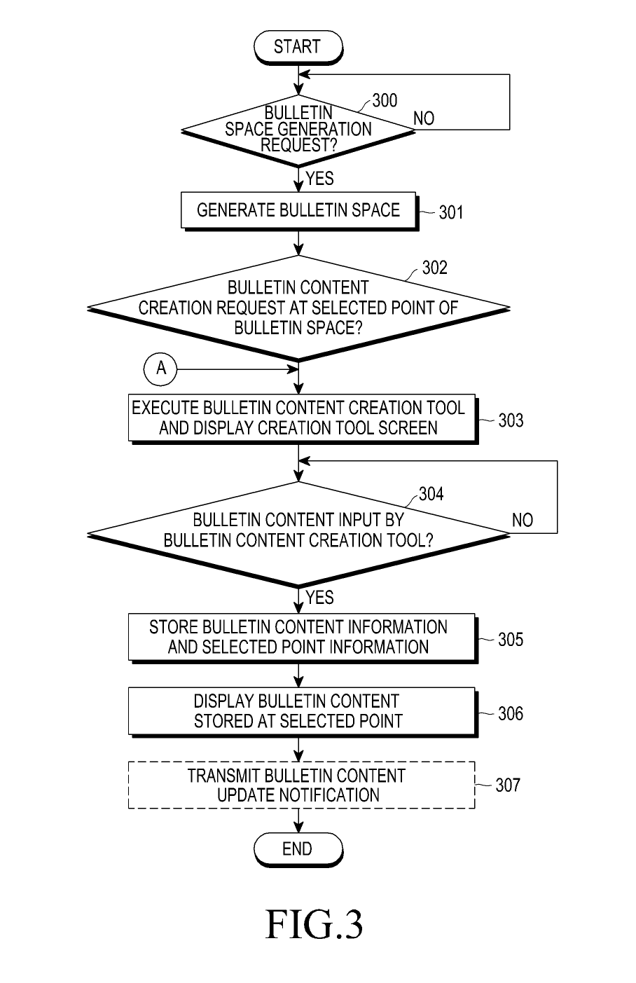

FIG. 3 is a flow diagram illustrating a process for providing a Social Networking Service (SNS) by the server terminal 100 according to an embodiment of the present invention.

Referring to FIG. 3, in step 300, the control unit 101 determines whether there is a bulletin space-generation request through the input unit 102. If there is a bulletin space-generation request, the control unit 101 generates a bulletin space in step 301; and, if not, the control unit 101 repeats step 300.

In step 302, the control unit 101 determines whether there is a bulletin content-creation request at a point in the bulletin space. If there is a bulletin content-creation request, the control unit 101 proceeds to step 303; and, if not, the control unit 101 repeats step 302.

In step 303, the control unit 101 executes a bulletin content-creation tool stored in the memory unit 103 and displays a bulletin content-creation tool screen on the display unit 104.

In step 304, the control unit 101 determines whether there is a bulletin content input by the bulletin content-creation tool through the input unit 102. If there is a bulletin content input, the control unit 101 proceeds to step 305; and, if not, the control unit 101 repeats step 304.

In step 305, the control unit 101 uses the memory unit 103 to store information about the input bulletin content and the bulletin space point selected to register the bulletin content.

In step 306 the control unit 101 uses the display unit 104 to display the input bulletin content information at the selected bulletin space point.

In step 307, the control unit 101 transmits a bulletin content update notification to at least one client terminal to notify the registration of the bulletin content.

As described above, an embodiment of the present invention generates a virtual bulletin space, registers bulletin content with a desired design, at a desired point in the virtual bulletin space, in a desired manner, and shares the bulletin content with other users, thereby making it possible to create user-specific content.

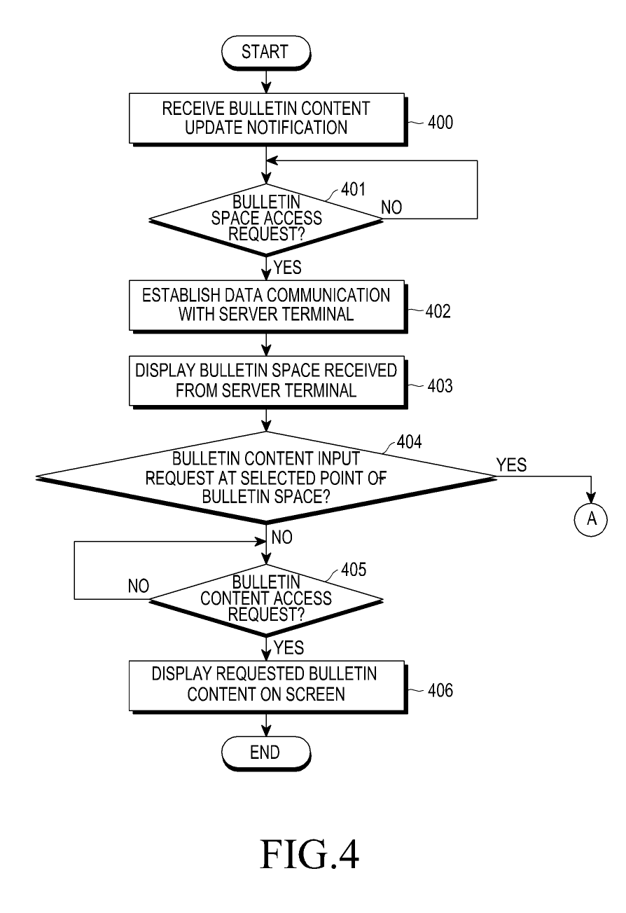

FIG. 4 is a flow diagram illustrating a process for accessing, by the client terminal 200, the server terminal 100 to use a Social Networking Service (SNS) according to an embodiment of the present invention.

Referring to FIG. 4, the control unit 201 receives a bulletin content update notification from the server terminal 100 in step 400. In step 401, the control unit 201 determines whether there is a bulletin space access request. If there is a bulletin space access request, the control unit 201 proceeds to step 402; and, if not, the control unit 201 repeats step 401.

In step 402, the control unit 201 establishes data communication with the server terminal 100.

In step 403, the control unit 201 uses the display unit 204 to display a bulletin space received from the server terminal 100.

In step 404, the control unit 201 determines whether there is a bulletin content input request at a selected point of the displayed bulletin space. If there is a bulletin content input request, the control unit 201 proceeds to step A, and if not, the control unit 201 proceeds to step 405. In step 405, the control unit 201 determines whether there is a bulletin content access request for accessing any one of one or more bulletin content present in the bulletin space.

After proceeding to step A, the control unit 201 performs steps 303 to 307 of FIG. 3 to perform a bulletin content storage process at a bulletin content input request.

If there is a bulletin content access request, the control unit 201 proceeds to step 406; and, if not, the control unit 201 repeats step 405.

In step 406, the control unit 201 uses the display unit 204 to display a bulletin content screen where the requested bulletin content is mapped to the selected point.

As described above, the present invention generates a virtual bulletin space, registers bulletin content with a desired design, at a desired point in the virtual bulletin space, in a desired manner, and shares the bulletin content with other users, thereby making it possible to create user-specific content.

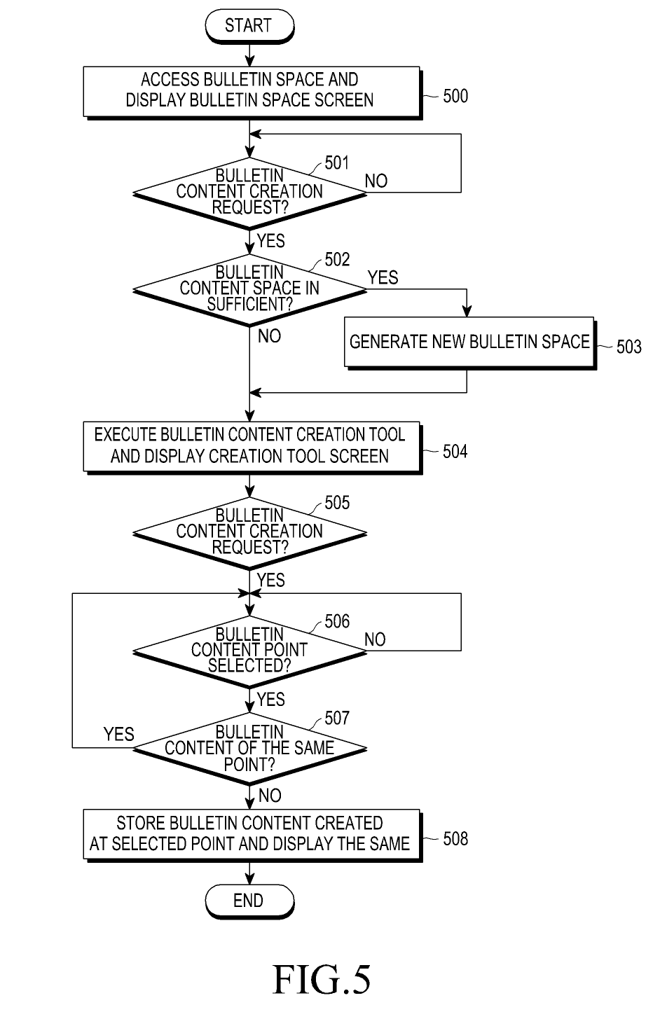

FIG. 5 is a flow diagram illustrating a process for accessing, by the client terminal 200, a bulletin space in the server terminal 100 to use a Social Networking Service (SNS) according to an embodiment of the present invention.

Referring to FIG. 5, in step 500, the control unit 201 accesses a bulletin space of the server terminal 100 through the data-communicating unit 205 and displays a bulletin space screen on the display unit 204.

In step 501, the control unit 201 determines whether there is a bulletin content-creation request. If there is a bulletin content-creation request, the control unit 201 proceeds to step 502; and, if not, the control unit 201 repeats step 501.

In step 502, the control unit 201 determines whether a bulletin content display space in the bulletin space is insufficient. If a bulletin content display space in the bulletin space is insufficient, the control unit 201 generates a new bulletin space in step 503; and, if not, the control unit 201 proceeds to step 504.

In step 504, the control unit 201 executes a bulletin content-creation tool stored in the memory unit 203 and displays a bulletin content-creation tool screen on the display unit 204.

In step 505, the control unit 201 determines whether the bulletin content-creation is complete. If the bulletin content-creation is complete, the control unit 201 proceeds to step 506; and, if not, the control unit 201 repeats step 505.

In step 506, the control unit 201 determines whether a bulletin content registration point is selected in the bulletin space. If a bulletin content registration point is selected in the bulletin space, the control unit 201 proceeds to step 507; and, if not, the control unit 201 repeats step 506.

In step 507, the control unit 201 determines whether there is another bulletin content at the same point. If there is another bulletin content at the same point, the control unit 201 returns to step 506 to reselect a bulletin content point; and, if not, the control unit 201 proceeds to step 508. In step 508, the control unit 201 uses the memory unit 203 to store the bulletin content generated at the selected point, and displays the same on the display unit 204.

As described above, the present invention generates a virtual bulletin space, registers bulletin content with a desired design, at a desired point in the virtual bulletin space, in a desired manner, and shares the bulletin content with other users, thereby making it possible to create user-specific content.

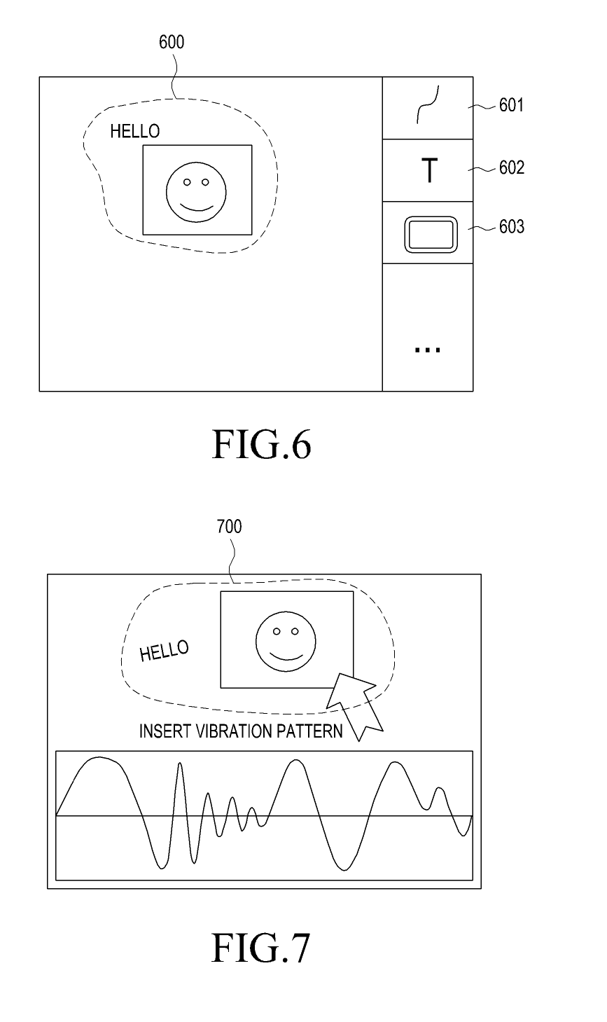

FIG. 6 illustrates a bulletin content-creation tool screen and bulletin content created in a bulletin space according to an embodiment of the present invention.

As illustrated in FIG. 6, at a request for creation of bulletin content in a bulletin space, the control unit 101 may use the display unit 104 to display a bulletin content-creation tool screen including a drawing function 601, a text function 602, and an image/video insertion function 603.

The user may use the functions of the bulletin content-creation tool to create bulletin content 600. The control unit 101 may use the display unit 104 to display the created bulletin content and the bulletin content-creation tool screen together.

FIG. 7 illustrates applying an effect to bulletin content according to an embodiment of the present invention.

As illustrated in FIG. 7, the server terminal 100 or the client terminal 200 may insert an effect of a vibration pattern at a bulletin space point for bulletin content as represented by a reference numeral 700, when creating the bulletin content by the functions of the bulletin content-creation tool. The user may personally edit a vibration pattern or may select a basic vibration pattern, so that the user may have a special feeling experience when selecting the bulletin content by touch.

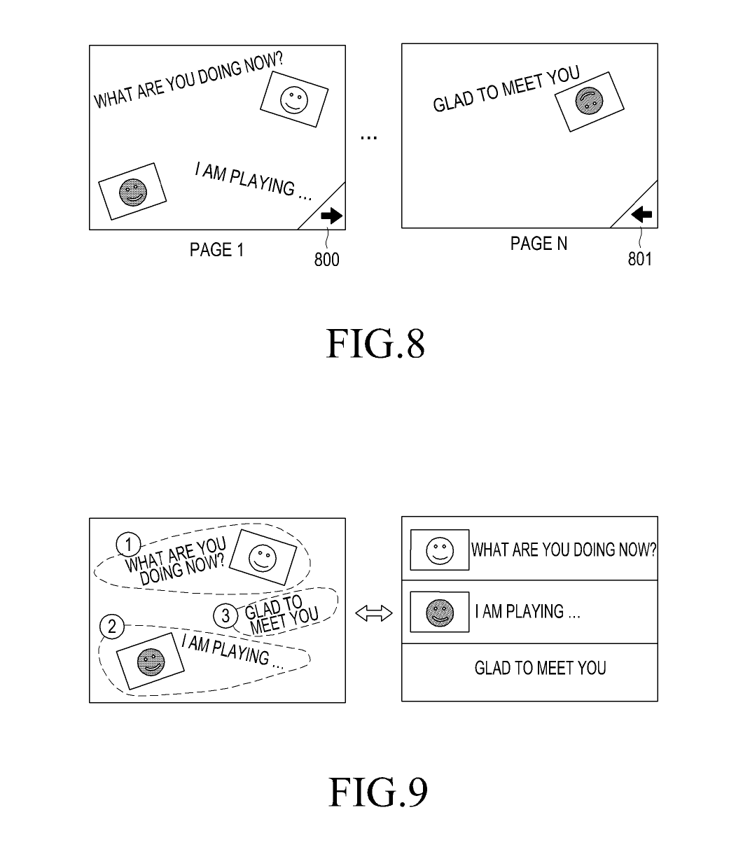

FIG. 8 illustrates supporting a multi-page mode according to an embodiment of the present invention.

As illustrated in FIG. 8, the server terminal 100 or the client terminal 200 may support a multi-page mode for generating a plurality of bulletin spaces in the server terminal 100 and displaying the generated bulletin spaces on the screen by displaying a previous page view arrow represented by a reference numeral 800 and a next page view arrow represented by a reference numeral 801.

FIG. 9 illustrates changing from a bulletin space screen to a list-type bulletin content screen according to an embodiment of the present invention.

As illustrated in FIG. 9, the server terminal 100 or the client terminal 200 may display a bulletin space including a plurality of bulletin content, at a point selected by the user, and may provide a function for changing from the bulletin space screen to a conventional list-type bulletin content display screen to display the conventional list-type bulletin content display screen to the user.

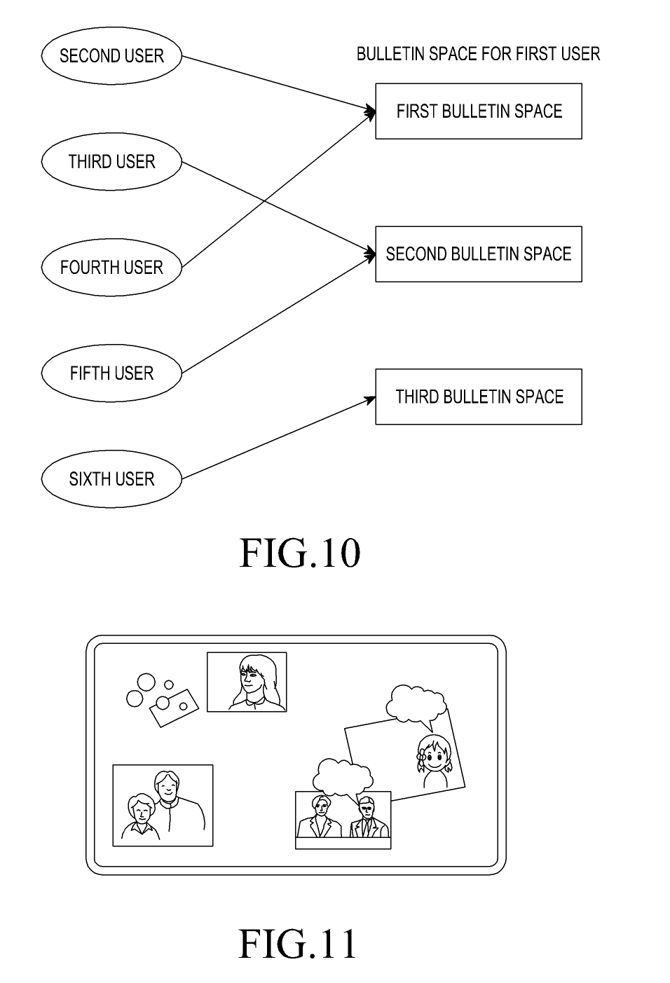

FIG. 10 illustrates a plurality of bulletin spaces and the relationship between users sharing the bulletin spaces according to an embodiment of the present invention.

Referring to FIG. 10, if a bulletin space for a first user includes a first bulletin space, a second bulletin space and a third bulletin space, a second user and a fourth user create and share bulletin content in the first bulletin space. The first user may then give the second and fourth users the right to use the first bulletin space so that only the second and fourth users can use the first bulletin space.

If a third user and a fifth user create and share bulletin content in the second bulletin space, the first user may give the third and fifth users the right to use the second bulletin space so that only the third and fifth users can use the second bulletin space.

If a sixth user creates and shares bulletin content in the third bulletin space, the first user may give the sixth user the right to use the third bulletin space so that only the sixth user can use the third bulletin space.

FIG. 11 illustrates a bulletin space screen including a plurality of bulletin content according to an embodiment of the present invention.

As illustrated in FIG. 11, the server terminal 100 and the client terminal 200 may display bulletin content, created freely by the user, in a chalkboard-type bulletin space at positions selected by the user. Although it has been described that bulletin content is created and shared in a two-dimensional bulletin space, bulletin content may also be created and shared in a three-dimensional bulletin space.

As described above, the information sharing apparatus and method according to embodiments of the present invention generates a virtual bulletin space, registers bulletin content with a desired design, at a desired point in the virtual bulletin space, in a desired manner, and shares the bulletin content with other users, thereby making it possible to create user-specific content.

Also, the information sharing apparatus and method according to embodiments of the present invention can provide an SNS through a personal terminal of a user, thus, making it possible to save web server maintenance costs.

While the invention has been shown and described with reference to embodiments thereof, it will be understood by those skilled in the art that various changes in form and details may be made therein without departing from the spirit and scope of the invention as defined by the appended claims and their equivalents.

What is claimed is:

1. An apparatus for sharing information in a virtual space, the apparatus comprising:
an input unit for receiving user input;
a memory unit for storing data to create bulletin content;
a display unit for displaying a bulletin content-creation screen; and
a control unit for generating, upon receiving a bulletin space-generation request, a bulletin space and displaying the bulletin space on the display unit; executing, upon receiving a bulletin content-creation request, a bulletin content-creation tool stored in the memory unit and displaying the bulletin content-creation tool on the display unit; and storing a bulletin content corresponding to the bulletin space, created by the bulletin content-creation tool, in the memory unit and displaying the bulletin content on the display unit.

2. The apparatus of claim 1, wherein the bulletin content-creation tool includes at least one of a note-taking input function, a text input function, a picture, voice and video attachment function, and a drawing function.

3. The apparatus of claim 1, wherein the control unit determines whether the size of a bulletin space is sufficient for bulletin content-creation at the bulletin space-generation request, and if the size of the bulletin space is insufficient, generates a new bulletin space.

4. The apparatus of claim 1, wherein, when a bulletin content is created by the bulletin content-creation tool, the control unit receives a display point of the created bulletin content in the bulletin space through the input unit, stores the created bulletin content corresponding to the bulletin content display point, and displays the created bulletin content on the display unit.

5. The apparatus of claim 4, wherein the control unit determines whether there is a bulletin content registered at the bulletin content display point, and, if there is no bulletin content already registered at the bulletin content display point stores the bulletin content at a bulletin space point without a bulletin content and displays the bulletin content on the display unit.

6. The apparatus of claim 1, wherein the control unit provides a bulletin content management right function to set a bulletin content management right when creating the bulletin content.

7. An apparatus for sharing information in a virtual space, the apparatus comprising:
an input unit for receiving user input;
a memory unit for storing data used to create bulletin content;
a display unit for displaying a bulletin content-creation screen;
a data-communicating unit for communicating with a server terminal; and
a control unit for connecting to the server terminal through the data-communicating unit and using the display unit to display a bulletin space provided by the server terminal; executing, upon receiving a bulletin content-creation request, a bulletin content-creation tool stored in the memory unit and displaying the bulletin content-creation tool on the display unit; and storing a bulletin content corresponding to the bulletin space, created by the bulletin content-creation tool, in the memory unit and displaying the bulletin content on the display unit.

8. The apparatus of claim 7, wherein the bulletin content-creation tool includes at least one of a note-taking input function, a text input function, a picture, voice and video attachment function, and a drawing function.

9. The apparatus of claim 7, wherein the control unit determines whether the size of a bulletin space is sufficient for bulletin content-creation at the bulletin space-generation request, and generates a new bulletin space if the size of the bulletin space is insufficient.

10. The apparatus of claim 7, wherein when a bulletin content is created by the bulletin content-creation tool, the control unit receives a display point of the created bulletin content in the bulletin space through the input unit, stores the created bulletin content corresponding to the bulletin content display point, and displays the created bulletin content on the display unit.

11. The apparatus of claim 10, wherein the control unit determines whether there is a bulletin content already registered at the bulletin content display point, and, if there is no bulletin content already registered at the bulletin content display point stores the bulletin content at a bulletin space point without a bulletin content and displays the bulletin content on the display unit.

12. The apparatus of claim 7, wherein the control unit provides a bulletin content management right function to set a bulletin content management right when creating the bulletin content.

13. A method for sharing information in a virtual space, the method comprising:
generating, upon receiving a bulletin space-generation request, a bulletin space and displaying the bulletin space on a screen;
executing, upon receiving a bulletin content-creation request, a bulletin content-creation tool stored in the memory unit and displaying the bulletin content-creation tool on the screen; and
storing, when a bulletin content is created by the bulletin content-creation tool, the created bulletin content corresponding to the bulletin space, and displaying the bulletin content on the screen.

14. The method of claim 13, wherein the bulletin content-creation tool includes at least one of a note-taking input function, a text input function, a picture, voice and video attachment function, and a drawing function.

15. The method of claim 13, further comprising:
determining whether the size of a bulletin space is sufficient for bulletin content-creation at the bulletin space-generation request; and
if the size of the bulletin space is insufficient, generating a new bulletin space.

16. The method of claim 13, wherein storing of the created bulletin content corresponding to the bulletin space and displaying the bulletin content on the screen comprises:
receiving a display point of the created bulletin content in the bulletin space when the bulletin content is created by the bulletin content-creation tool; and
storing the created bulletin content corresponding to the bulletin content display point and displaying the created bulletin content on the screen.

17. The method of claim 16, further comprising:
determining whether there is a bulletin content already registered at the bulletin content display point; and
if there is no bulletin content already registered at the bulletin content display point, storing the bulletin content at a bulletin space point without a bulletin content.

18. The method of claim 13, further comprising:
providing a bulletin content management right function to set a bulletin content management right when creating the bulletin content.

19. A method for sharing information in a virtual space, comprising:
upon receiving a request for generation of a bulletin space for creation of a bulletin content, connecting communication with a server terminal and displaying a bulletin space, provided by the server terminal, on a screen;
upon receiving a bulletin content-creation request, executing a bulletin content-creation tool stored in the memory unit and displaying the bulletin content-creation tool on the on the screen; and
storing a bulletin content corresponding to the bulletin space, created by the bulletin content-creation tool, and displaying the bulletin content on the screen.

20. The method of claim 19, wherein the bulletin content-creation tool includes at least one of a note-taking input function, a text input function, a picture, voice and video attachment function, and a drawing function.

21. The method of claim 19, further comprising:
determining whether the size of a bulletin space is sufficient for bulletin content-creation at the bulletin space-generation request; and
if the size of the bulletin space is insufficient, generating a new bulletin space.

22. The method of claim 19, wherein storing of the created bulletin content corresponding to the bulletin space and displaying the bulletin content on the screen comprises:
receiving a display point of the created bulletin content in the bulletin space when the bulletin content is created by the bulletin content-creation tool; and
storing the created bulletin content corresponding to the bulletin content display point and displaying the created bulletin content on the screen.

23. The method of claim 22, further comprising:
determining whether there is a bulletin content already registered at the bulletin content display point; and
if there is no bulletin content already registered at the bulletin content display point, storing the bulletin content at a bulletin space point without a bulletin content.

24. The method of claim 19, further comprising:
providing a bulletin content management right function to set a bulletin content management right when creating the bulletin content.
